(19) United States
(12) Patent Application Publication
(10) Pub. No.: US 2018/0099334 A1
(43) Pub. Date: Apr. 12, 2018

(54) METHOD AND APPARATUS FOR ADDITIVELY MANUFACTURING MULTI-MATERIAL PARTS

(71) Applicants: Volker Peters, Wienhausen (DE); Christoph Wangenheim, Hemmingen (DE); Madison Suzann Burns, Celle (DE)

(72) Inventors: Volker Peters, Wienhausen (DE); Christoph Wangenheim, Hemmingen (DE); Madison Suzann Burns, Celle (DE)

(73) Assignee: Baker Hughes Incorporated, Houston, TX (US)

(21) Appl. No.: 15/291,793

(22) Filed: Oct. 12, 2016

(51) Int. Cl. B22F 3/105; B33Y 10/00; B29C 67/00; B22F 3/10; B22F 3/15; B22F 3/24; B28B 1/00

(52) U.S. Cl. CPC B22F 3/1055; B33Y 10/00; B29C 67/0077; B22F 3/1021; B22F 2998/10; B22F 3/24; B28B 1/001; B22F 2003/248; B22F 3/15

(57) ABSTRACT

A method to additively manufacture multi-material parts including directly depositing a part material through a print head having a number of degrees of freedom to a growing part, directly depositing a binder through the print head or a different print head having a number of degrees of freedom to the growing part simultaneously with or temporally shifted from the depositing of the part material. A method to additively manufacture multi-material parts including directly depositing to a growing part, a part material that is itself coated with a binder, through a print head having a number of degrees of freedom.

### BACKGROUND

Additive manufacturing is a growing industry, having great potential and reduced material cost. Various processes have been developed to produce parts of certain materials. These tend to be single material parts such that fusion of the utilized powdered particles can occur during deposition of the same. In some cases however, it is desired to use different materials in a produced part. Where the materials cannot be handled in the same way by fusing powder particles upon deposition, alternatives were needed. One method of producing a multi material part employs a powder bed process where a powder bed of a material is applied to a build plate and then a binder is used, as a laser for example would have been in a single metal process, to hold the desired particles together. Then the balance of the particles are removed from the build plate and another material is layered onto the build plate followed by additional binder in the sections where that material is desired to be maintained. The unbound second material is then cleared away from the build plate and so on until the part is completed in a green form. The part may then be sintered to be finished. While the process does achieve parts with multiple materials, it is cumbersome, time consuming, potentially wasteful and potentially prone to contamination of some sections of material with another of the materials particularly at margins of the bound materials. The art then continues to seek alternative processes and apparatus for additively manufacturing multi-material parts.

### SUMMARY

A method to additively manufacture multi-material parts including directly depositing a part material through a print head having a number of degrees of freedom to a growing part, directly depositing a binder through the print head or a different print head having a number of degrees of freedom to the growing part simultaneously with or temporally shifted from the depositing of the part material.

A method to additively manufacture multi-material parts including directly depositing to a growing part, a part material that is itself coated with a binder, through a print head having a number of degrees of freedom.

### BRIEF DESCRIPTION OF THE DRAWINGS

The following descriptions should not be considered limiting in any way. With reference to the accompanying drawings, like elements are numbered alike:

FIG. 1 is a schematic view of a configuration for additively manufacturing multi-material parts;

FIG. 1A is an enlarged view of a portion of FIG. 1; and

FIG. 2 is a schematic view of an alternate configuration for additively manufacturing multi-material parts.

### DETAILED DESCRIPTION

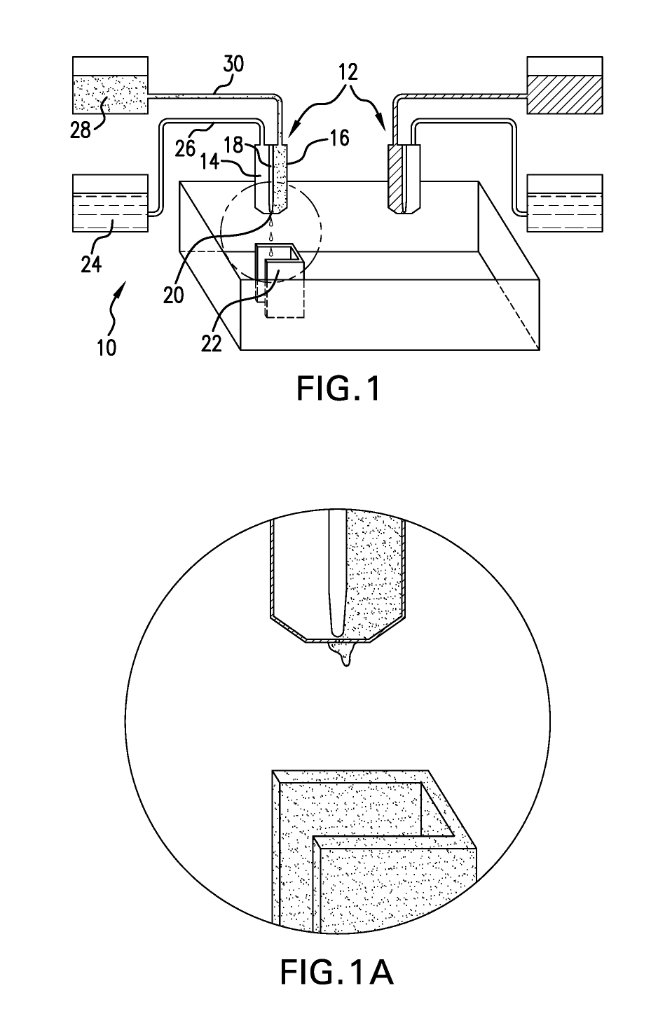

Referring to FIG. 1 and FIG. 1A, a first embodiment of a configuration 10 to additively manufacture multi-material parts is illustrated. The illustration is schematic and intended to convey that parts may be additively manufactured by jetting (applying) both binder and material to a part in progress while the part is free standing. There is no need to apply heat to the part while it is being grown (e.g. a laser) but rather the material of the part or the multiple materials of the part are bound together temporarily using a binder and then the entire part may be sintered to produce a final product.

In the embodiment of FIG. 1, two print heads 12 are illustrated. Clearly more or one can be substituted. Each print head 12 is configured to accept at least two feed streams of material. One will be a binder 14 that may be selected from inorganic or organic gels, liquids and powders such as but not limited to silicates, starches, paraffins, lignosulfonates, furan resins, phenolic resins or aqueous based binders (including those that may penetrate into a part material and create a binded voxel within the powdered material), while the other will be a part material 16 such as ceramics, plastics, metals or organic materials, for example. It is also to be noted that powdered materials that are coated (at the particulate level) with a binder are also contemplated for use. Such materials include Metallic materials; metallic composites; metal matrix composites (continuous fiber) including continuous-fiber reinforced boron/aluminum, graphite/aluminum, graphite/magnesium; Metal matrix composites (discontinuous fiber)—silicon-carbide particulate reinforced aluminum, carbon nanotube reinforced composites (e.g. carbon nanotubes in an alumina matrix); amorphous metals; ceramic materials including aluminum oxides, silicates, zirconium oxides, silicon carbides, silicon nitrides, aluminum nitrides; organic materials; and inorganic materials including but not limited to titanium alloys, iron alloys, nickel-based alloys, ferrous metals, cobalt-based alloys, aluminum alloys magnesium alloys, rare earth alloys, copper alloys, and tungsten carbide. In some embodiments the materials used are selected for their ability to create binding properties based upon a change in environment such as light level, wavelength or intensity, temperature, atmosphere (gas, liquid, plasma), etc. Materials exhibiting such properties include Inorganic or organic gels, liquids and powders such as but not limited to silicates, starches, paraffins, lignosulfonates, furan resins, phenolic resins or aqueous based binders (including those that may penetrate into a part material and create a binded voxel within the powdered material).

Print head 12 is bifurcated by divider 18 to keep materials 14 and 16 separate until ejected from the print head 12. The materials, binder 14 and part material 16 are mixed at the outlet 20 of the print head 12 and then applied to the part 22 being grown. Due to action of the binder, the applied material is maintained in a position that is dictated by the design program for the part. Binder 14 is conveyed to the print head from a reservoir 24 through conduit 26, which may be a longer conduit extending from a remote location to a very short conduit where the reservoir is essentially within or on the print head 12. The same is true for a part material reservoir 28 such as a feedstock tank, from which a volume of part material 16 is conveyed to the print head 12 through a conduit 30. The print head and the supply of material 14 or 16 is controlled via a computer control system in ways that are known to the art and need not be explained here.

It will be appreciated that while the other print head 12 has not been separately numbered, the components are the same as those discussed above. It is contemplated however that the same or different materials could be applied with the other print head 12.

While two materials 14 and 16 have been described as being applied through print head 12 above it is to be understood that the inventors hereof contemplate using more than two materials in a print head. There is nothing inherently limited about the two material head. It can easily be divided to accommodate and apply more than two materials. The additional material may be another binder or another part material or both to facilitate growing more complex parts quickly and efficiently.

It is also to be understood that the grown part is not limited to layers of material that cover a plane through the part but rather the various materials applicable through the print head may be placed in only a discreet part of the layer with other materials making up other portions of the layer. This provides great flexibility to additive manufacture and increases both complexity of parts possible and speed of production.

It is further to be noted that though two print heads are illustrated, there is no limit to the number of heads used other than practicality in the space available.

After the part is configured (grown), it, in some embodiments, is sintered to create its final condition. In some instances, the sintering temperature of the various materials utilized will be similar, i.e. within a few degrees of each other such as aluminum oxide and steel which are both in the range of 1100 degrees C., while in others it is possible to employ materials having substantially disparate sintering temperatures (such as aluminum oxide and bronze, for example) provided the higher sintering temperature is below a point at which other of the materials in the part would thermally decompose as that would be counterproductive unless for the particular process, there would be an advantage to thermally decomposing one or more of the materials of the part. In some cases it is beneficial to remove the binder during the sintering process and hence thermal decomposition thereof in such an embodiment would not be prohibited but rather sought.

Some embodiments will use a transformation into a liquid phase during the sintering process. This may be for one or more of the materials used to grow a particular part. More particularly, it is contemplated that in a multi-material part, one, more than one, or all of the materials used may be transformed to liquid phase during a sintering operation. During the liquid phase of any such material, it is further contemplated that for some embodiments the liquid material will infiltrate other materials used rather than merely bond with them. Such infiltration can be employed to change structural characteristics of the grown part such as for example by infiltrating a bronze material through the grown part to manage shrinkage of the part.

Additionally to the foregoing, some embodiments hereof may also add a hot isostatic pressing operation to the production of the part. In some embodiments the pressing is carried out after the sintering operation.

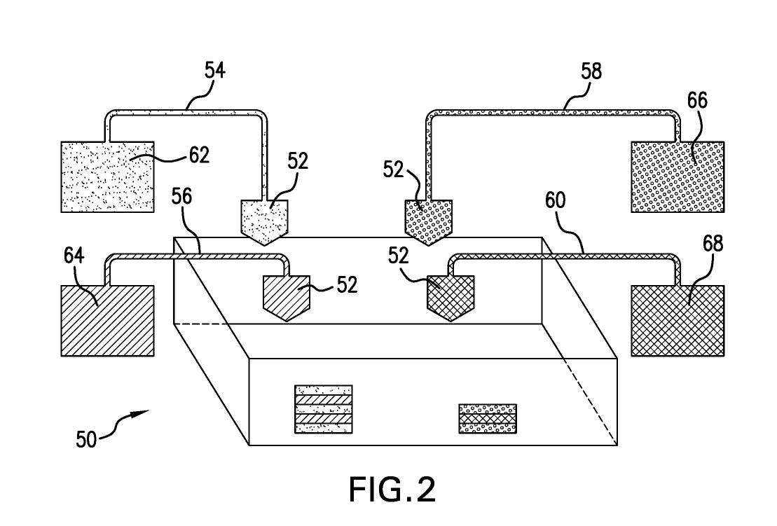

Referring to FIG. 2, an alternate embodiment is illustrated where printing heads do not apply multiple materials through a single head but rather there are multiple printing heads all dedicated to a material. The printing heads may each have a different material or they may all have the same material and any combinations between these extremes is contemplated.

As illustrated a configuration to additively manufacture multi-material parts 50 is illustrated. Included are four print heads 52 each having a single material associated therewith. As noted it is contemplated that more than one head 52 might have the same material in embodiments. Each head 52 is connected via a conduit, 54, 56, 58, 60 to a respective reservoir of material, be it a binder or a part material, 62, 64, 66, and 68. Computer control allows the deposition of part material or binder at selected locations of the free standing part while growing the same such that a green completed part is ready for sintering at the conclusion of the growing process.

In either embodiment, it is to be recognized that multiple binders and multiple part materials are contemplated and may be deposited to create many different types and material parts including parts made of a material and insulated by another material within yet another material. For example, it is contemplated that a part may be grown that includes a housing, an insulator (electrical isolator) within the housing and a conductor (electrical conductor) within the insulation (e.g. an electrical feedthrough). Further, it is contemplated that the configuration is configured to hold a pressure differential from one end to the other end of the feedthrough. This is because the insulator and conductor are intrinsically embedded in the part rather than placed there after the fact, which would introduce a leak path. In the grown part, there is no leak path and hence the ability to hold a pressure differential across the feedthrough.

Part materials contemplated are: cobalt, nickel, copper, chromium, aluminum, iron, steel, stainless steel, titanium, tungsten, or alloys and mixtures thereof, magnetically responsive materials, polyetheretherketone (PEEK™), carbon-based materials (e.g., graphite, graphene, diamond, etc.), and/or glass. Specific, nonlimiting examples, of materials that may be included in the precursor material source 112 may include PA12-MD(A1), PA12-CF, PA11, 18 Mar 300/1.2709, 15-5/1.4540, 1.4404 (316L), Alloy 718, Alloy 625, CoCrMo, UNS R31538, Ti6AI4V and AlSi10Mg, Alloy 945x, 17-4/1.4542, Alloy 925, CrMnMoN-steel, CoCr Alloys (STELLITE®), CoNi Alloy, MP35 or equivalent, 4140, 4145, WC—Ni, WC—Co, and/or W. As another example, material in the precursor material source 112 may include fine particles of metal or metal alloy material intermixed with fine particles of ceramic material, the material being configured to form a metallic-ceramic composite material (e.g., a cermet), in which ceramic particles are embedded within a metal or metal alloy matrix, upon melting and coalescence of the particles of metal and/or metal alloy material.

Binder materials contemplated include but are not limited to: aqueous-based binders, silicates, starches, paraffins, bentonite, lignosulfonates, polyacrylates, furan resins or phenolic resins.

Set forth below are some embodiments of the foregoing disclosure:

### Embodiment 1

A method to additively manufacture multi-material parts including directly depositing a part material through a print head having a number of degrees of freedom to a growing part, directly depositing a binder through the print head or a different print head having a number of degrees of freedom to the growing part simultaneously with or temporally shifted from the depositing of the part material.

### Embodiment 2

The method as in any prior embodiment further comprising mixing the part material and the binder in the print head prior to depositing to the growing part.

### Embodiment 3

The method as in any prior embodiment wherein the part material and the binder are alternatingly deposited through the print head.

### Embodiment 4

The method as in any prior embodiment wherein the part material is deposited through the print head having one or more part materials deposited therethrough.

### Embodiment 5

The method as in any prior embodiment wherein the binder is deposited through the print head having one or more binders deposited therethrough.

### Embodiment 6

The method as in any prior embodiment wherein the depositing is by layer.

### Embodiment 7

The method as in any prior embodiment wherein the depositing is by part layer.

### Embodiment 8

The method as in any prior embodiment wherein the method further comprises depositing more than one part material in a single layer of the growing part.

### Embodiment 9

The method of any prior embodiment further comprising sintering the part.

### Embodiment 10

The method of any prior embodiment wherein one or more of the part material and the binder are selected to have sintering temperatures allowing the materials to transform into a liquid phase sintering state during the sintering.

### Embodiment 11

The method of any prior embodiment wherein one or more of the part material and the binder is of higher sintering temperature than the other of the one or more of the part material and the binder.

### Embodiment 12

The method of any prior embodiment wherein the binder is removed during the sintering.

### Embodiment 13

The method of any prior embodiment further comprising hot isostatically pressing (HIP) after sintering.

### Embodiment 14

The method of any prior embodiment wherein one or more of the part material and the binder is an electrical isolator and one or more of the part material and the binder is electrically conductive.

### Embodiment 15

The method of any prior embodiment wherein the part material is one of a metal powder and a ceramic powder.

### Embodiment 16

The method of any prior embodiment wherein the binder is activated by light.

### Embodiment 17

The method of any prior embodiment wherein the binder is activated by environmental change.

### Embodiment 18

The method of any prior embodiment wherein the electrically conductive and electrically isolating materials are grown in the part to form electrical feedthrough connections intrinsically embedded in the structure of the part.

### Embodiment 19

The method of any prior embodiment wherein the feedthrough connection reaches from a first side to a second side and is configured to support differential pressure acting on the first side and second side.

### Embodiment 20

A method to additively manufacture multi-material parts including directly depositing to a growing part, a part material that is itself coated with a binder, through a print head having a number of degrees of freedom.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

1. A method to additively manufacture multi-material parts comprising:
directly depositing a part material through a print head having a number of degrees of freedom to a growing part;
directly depositing a binder through the print head or a different print head having a number of degrees of freedom to the growing part simultaneously with or temporally shifted from the depositing of the part material.

2. The method as claimed in claim 1 further comprising mixing the part material and the binder in the print head prior to depositing to the growing part.

3. The method as claimed in claim 1 wherein the part material and the binder are alternatingly deposited through the print head.

4. The method as claimed in claim 1 wherein the part material is deposited through the print head having one or more part materials deposited therethrough.

5. The method as claimed in claim 1 wherein the binder is deposited through the print head having one or more binders deposited therethrough.

6. The method as claimed in claim 1 wherein the depositing is by layer.

7. The method as claimed in claim 1 wherein the depositing is by part layer.

8. The method as claimed in claim 1 wherein the method further comprises depositing more than one part material in a single layer of the growing part.

9. The method of claim 1 further comprising sintering the part.

10. The method of claim 9 wherein one or more of the part material and the binder are selected to have sintering temperatures allowing the materials to transform into a liquid phase sintering state during the sintering.

11. The method of claim 9 wherein one or more of the part material and the binder is of higher sintering temperature than the other of the one or more of the part material and the binder.

12. The method of claim 9 wherein the binder is removed during the sintering.

13. The method of claim 9 further comprising hot isostatically pressing (HIP) after sintering.

14. The method of claim 1 wherein one or more of the part material and the binder is an electrical isolator and one or more of the part material and the binder is electrically conductive.

15. The method of claim 1 wherein the part material is one of a metal powder and a ceramic powder.

16. The method of claim 1 wherein the binder is activated by light.

17. The method of claim 1 wherein the binder is activated by environmental change.

18. The method of claim 14 wherein the electrically conductive and electrically isolating materials are grown in the part to form electrical feedthrough connections intrinsically embedded in the structure of the part.

19. The method of claim 17 wherein the feedthrough connection reaches from a first side to a second side and is configured to support differential pressure acting on the first side and second side.

20. A method to additively manufacture multi-material parts comprising:
directly depositing to a growing part, a part material that is itself coated with a binder, through a print head having a number of degrees of freedom.
